(19) United States
(12) Patent Application Publication
(10) Pub. No.: US 2018/0155527 A1
(43) Pub. Date: Jun. 7, 2018

(54) MEDIA AND DEVICES FOR WATER FILTRATION

(71) Applicant: HONEYWELL INTERNATIONAL INC., Morris Plains, NJ (US)

(72) Inventors: Marilyn Wang, Shanghai (CN); Xingping Wang, Shanghai (CN)

(21) Appl. No.: 15/887,731

(22) Filed: Feb. 2, 2018

Related U.S. Application Data
(63) Continuation of application No. PCT/CN2015/085938, filed on Aug. 3, 2015.

(51) Int. Cl. C08K 5/17; C02F 1/00; C02F 1/62; C08L 33/20

(52) U.S. Cl. CPC C08K 5/17; C02F 1/001; C02F 2101/20; C08L 33/20; C08L 2205/16; C02F 1/62

(57) ABSTRACT

Media and devices for water filtration are described herein. One method of forming a water filter medium includes modifying a polymeric fiber using an amine compound to form a chelating fiber, and combining the chelating fiber and an unmodified polymeric fiber to form a hybrid water filter medium.

### TECHNICAL FIELD

The present disclosure relates to media and devices for water filtration.

### BACKGROUND

With increasing environmental concerns, more attention is being paid to the removal of Total Organic Carbon (TOC) and/or heavy metal ions from drinking water. Water pollution from TOC and heavy metals, notably arsenic, lead, and mercury, may threaten public health.

Previous approaches to purifying drinking water may use reverse osmosis, for instance. While reverse osmosis is environmentally friendly in that it does not produce or require hazardous chemicals, it may remove desirable elements from water. Further, the process of reverse osmosis may involve a large quantity of water, which may burden home septic systems.

### BRIEF DESCRIPTION OF THE DRAWINGS

FIG. 1 illustrates a method of forming a water filter medium in accordance with one or more embodiments of the present disclosure.

FIG. 2 illustrates a flow chart associated with forming a water filter medium in accordance with one or more embodiments of the present disclosure.

FIG. 3 illustrates a device including a water filter medium for filtering water in accordance with one or more embodiments of the present disclosure.

### DETAILED DESCRIPTION

Media and devices for water filtration are described herein. For example, one or more embodiments include modifying a polymeric fiber using an amine compound to form a chelating fiber, and combining the chelating fiber and an unmodified polymeric fiber to form a hybrid water filter medium.

Embodiments of the present disclosure can include a hybrid filter media that can remove Total Organic Carbon (TOC) (e.g., organic compounds), as well as heavy metal ions, from drinking water. Whereas previous approaches utilizing reverse osmosis may remove desirable elements from water, embodiments of the present disclosure may target TOC and heavy metal ions while leaving other, desirable elements.

Embodiments herein can include a bi-absorptive activated carbon fiber (ACF) media created though the combination of an unmodified polymeric fiber (e.g., an activated carbon fiber) with a modified chelating fiber. ACF can remove TOC from drinking water, for instance, while the modified chelating fiber can remove heavy metal ions by chelating them. Thus, the combination of the ACF and the modified chelating fiber can be utilized to simultaneously remove TOC and heavy metal ions.

The formation of the modified chelating fiber can be carried out through the amination of acrylic (e.g., polyacrylic) fiber, for instance. Depending on which metal ion(s) are targeted, the acrylic fiber can be modified to form different substituent groups.

Embodiments of the present disclosure can be tailored to specific needs. For instance, in some areas, TOC may present a larger problem than heavy metal ions. A filter medium in accordance with one or more embodiments of the present disclosure can include an increased ACF to modified fiber ratio such that the TOC may be effectively removed. In some areas, heavy metal ions may present a larger problem than TOC. A filter medium in accordance with one or more embodiments of the present disclosure can include a decreased ACF to modified fiber ratio such that the heavy metal ions may be effectively removed.

Further, the types and/or identities of heavy metal ions in a particular area can dictate the composition of the modified chelating fiber. Thus, embodiments of the present disclosure can be adapted to deal with a variety of water impurities.

In some embodiments, the filter media can be a spun and/or woven fabric sheet. The sheet can be sized and/or shaped to be accepted into various filter devices. In some embodiments, the sheet can have a thickness between 1.4 and 2 millimeters. In some embodiments, the filter media can be processed into nonwoven media because the fineness and/or length of the fiber can be controlled, for instance.

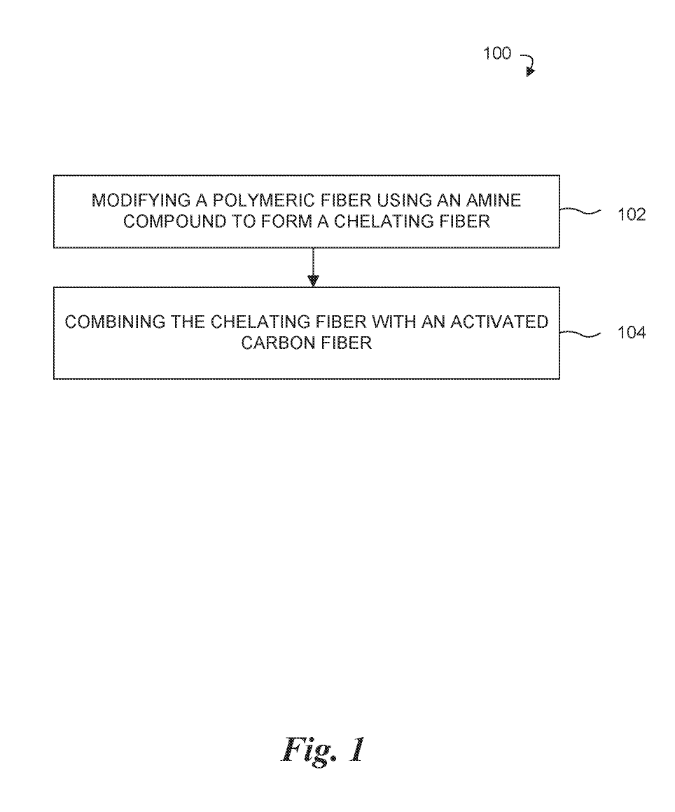

FIG. 1 illustrates a method 100 of forming a water filter medium in accordance with one or more embodiments of the present disclosure.

At block 102, the method 100 includes modifying a polymeric fiber (sometimes generally referred to herein as “fiber”) using an amine compound to form a chelating fiber. In some embodiments, the fiber can be an acrylonitrile fiber (e.g., polyacrylonitrile (PAN)). Polyacrylonitrile can be modified (e.g., easily modified) and can exhibit stability in aqueous media for prolonged times. In some embodiments, the fiber can be a polyvinyl alcohol fiber. In some embodiments, the fiber can be a polypropylene fiber. In some embodiments, the fiber can be an acrylic fiber.

Modifying the fiber can include treating the fiber with an amine compound (e.g., applying an amination treatment). The amine compound can be, for instance, hydrazine, hydroxylamine hydrochloride, ethanolamine, ethylene diamine, tetramethylene diamine and/or diethylene triamine.

In some embodiments, the modification can include the conversion of CEN groups to amide NH—C═O groups due to the reaction of amine compound(s) with the polymeric chains of the fibers. The formation of crosslinks and/or chemical groups (NH, NH2, etc.) can process the reaction. For example, a primary amine can react with the fiber to form the modified fiber as below:

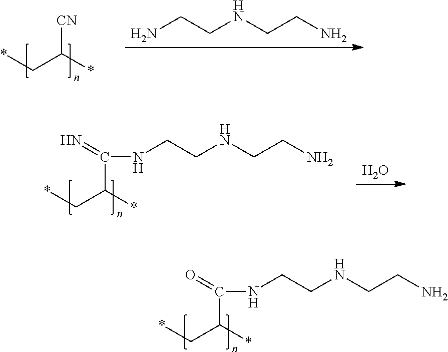

A secondary amine can react with the fiber to form the modified fiber as below, for instance:

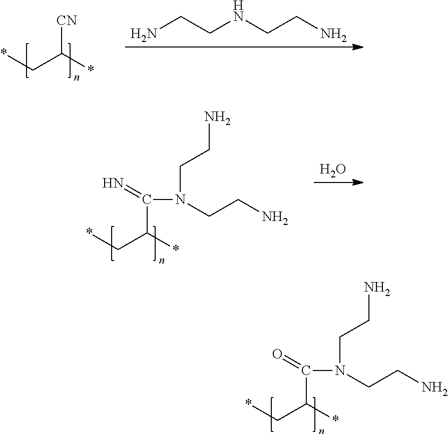

With respect to chelating metal ions, acrylonitrile has non-bonding lone pairs of electrons of nitrogen and oxygen atoms. In some embodiments, sulfur and/or phosphorus can include non-bonding lone pairs of electrons. The atoms with non-bonding lone pair electrons can form coordinate bonds with metal ions in drinking water (chelation). Thus, the modified chelating fiber can chelate metal ions by an example mechanism (in the case of oxygen):

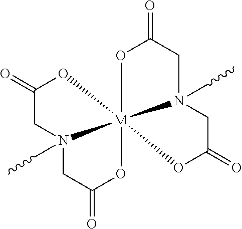

In some embodiments, the chelating groups can be amide groups (as described above). In some embodiments, the chelating groups can be amidoxime groups. In some embodiments, the chelating groups can be amine groups. In some embodiments, the chelating groups can be thiourea groups.

As previously discussed, chelation can remove the heavy metal ions from the drinking water. In some embodiments, the metal ion(s) to be chelated may determine the amination treatment used to modify the fiber. That is, the type and/or identity of ion(s) present in drinking water can be used to tailor the modified chelating fiber. The identities and/or types of the metal ions can be determined by sampling the drinking water, for instance.

For example, chelating groups containing phosphorus (e.g., phosphorus chelating fibers) can be used to chelate (e.g., remove from water) copper ions, zinc ions, cadmium ions, and/or mercury ions, for instance. For example, the below chelate fiber can be used to chelate copper ions, zinc ions, cadmium ions, and/or mercury ions:

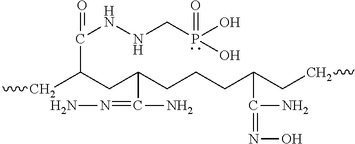

Chelating groups containing sulfur (e.g., sulfur chelating fibers) (e.g., fibers modified using thiourea, polythioethers, and/or thioamide) can be used to chelate silver ions, gold ions, and/or arsenic ions, for instance. For example, the below chelate fiber can be used to chelate silver ions, gold ions, and/or arsenic ions:

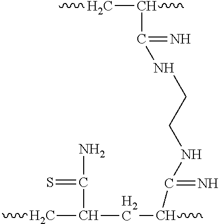

Chelating groups containing amino groups (e.g., amino chelating fibers) can be used to chelate copper ions, nickel ions, iron ions, zinc ions, and/or lead ions, for instance. For example, the below chelate fiber can be used to chelate copper ions, nickel ions, iron ions, zinc ions, and/or lead ions:

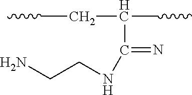

Different chelating groups can be used simultaneously. That is, the modification of the fiber can include the formation of a plurality of different chelating groups (e.g., amino chelating fibers and phosphorus chelating fibers).

At block 104, the method 100 includes combining the chelating fiber and an unmodified polymeric fiber (e.g., ACF) to form a hybrid water filter medium. As referred to herein, an “unmodified” fiber refers to a fiber to which an amination treatment has not been applied (e.g., commercially-available activated carbon fiber).

Manners of combining the chelating fiber with the unmodified acrylic fiber are not intended to be limited in embodiments of the present disclosure. For example, the fibers can be woven together. In some embodiments, the fibers can be spun together. In some embodiments, the fibers can be combined such that they form a fabric and/or sheet. In some embodiments, the fibers can be combined into a nonwoven medium.

The unmodified acrylic fiber can be an activated carbon fiber (ACF), for instance. The composition of the ACF is not intended to be limited herein. For example, the ACF can include activated (e.g., carbonized) PAN, phenol resin, pitch, and/or cellulose fibers.

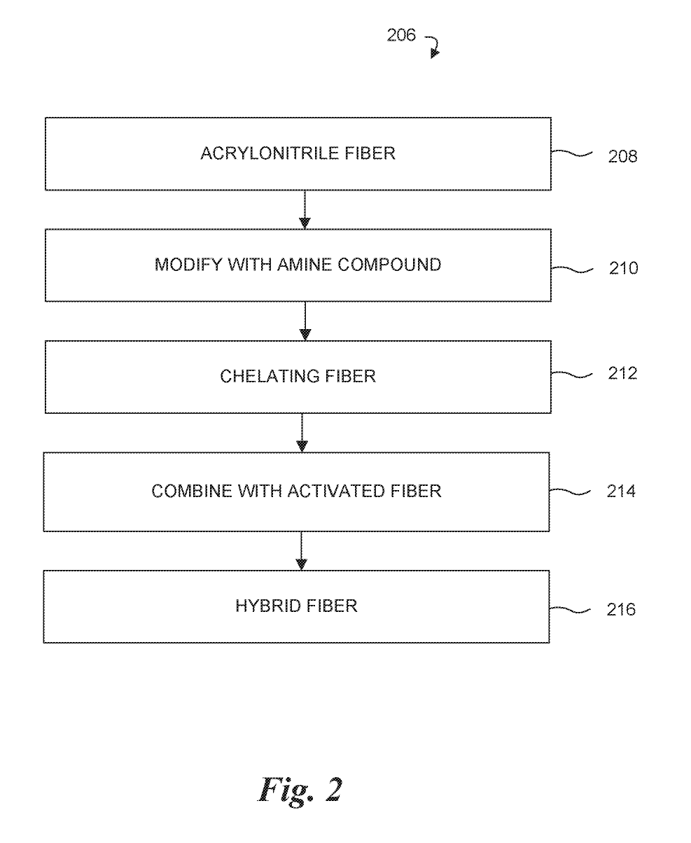

FIG. 2 illustrates a flow chart 206 associated with forming a water filter medium in accordance with one or more embodiments of the present disclosure.

An acrylonitrile fiber 208 can be modified with an amine compound at 210 to form a chelating fiber 212. Modifying the fiber can include treating the fiber with an amine compound (e.g., an amination treatment). The amine compound can be, for instance, hydrazine, hydroxylamine hydrochloride, ethanolamine, ethylene diamine, tetramethylene diamine and/or diethylene triamine.

In some embodiments, the modification can include the conversion of CEN groups to amide NH—C═O groups due to the reaction of amine compound(s) with the polymeric chains of the fibers. The formation of crosslinks and/or chemical groups (NH, NH2, etc.) can process the reaction.

The chelating fiber 212 can include chelating groups. In some embodiments, the chelating groups can be amide groups (as described above). In some embodiments, the chelating groups can be amidoxime groups. In some embodiments, the chelating groups can be amine groups. In some embodiments, the chelating groups can be thiourea groups.

In some embodiments, the metal ion(s) to be chelated may determine the amination treatment used to modify the fiber. That is, the type and/or identity of ion(s) present in drinking water can be used to tailor the modified chelating fiber. The identities and/or types of the metal ions can be determined by sampling the drinking water, for instance.

For example, chelating groups containing phosphorus (e.g., phosphorus chelating fibers) can be used to chelate (e.g., remove from water) copper ions, zinc ions, cadmium ions, and/or mercury ions, for instance. Chelating groups containing sulfur (e.g., sulfur chelating fibers) (e.g., fibers modified using thiourea, polythioethers, and/or thioamide) can be used to chelate silver ions, gold ions, and/or arsenic ions, for instance. Chelating groups containing amino groups (e.g., amino chelating fibers) can be used to chelate copper ions, nickel ions, iron ions, zinc ions, and/or lead ions, for instance. For example, the below chelate fiber can be used to chelate copper ions, nickel ions, iron ions, zinc ions, and/or lead ions.

The chelating fiber 212 can be combined with an unmodified fiber at 214 to form a hybrid fiber 216. Manners of combining the chelating fiber 212 with the unmodified acrylic fiber are not intended to be limited in embodiments of the present disclosure. For example, the fibers can be woven together. In some embodiments, the fibers can be spun together. In some embodiments, the fibers can be combined such that they form a fabric and/or sheet. In some embodiments, the fibers can be combined into a nonwoven medium.

The unmodified acrylic fiber can be an activated carbon fiber (ACF), for instance. The composition of the ACF is not intended to be limited herein. For example, the ACF can include activated (e.g., carbonized) PAN, phenol resin, pitch, and/or cellulose fibers.

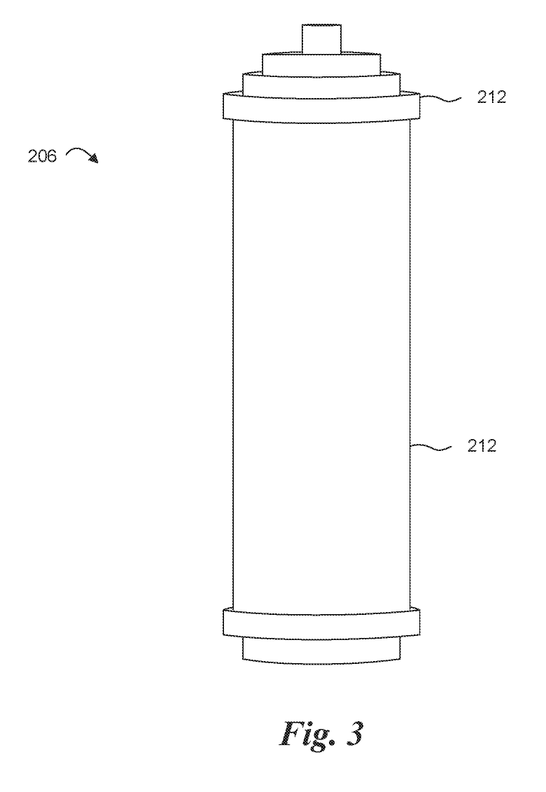

FIG. 3 illustrates a device 318 including a water filter medium for filtering water in accordance with one or more embodiments of the present disclosure. As shown in FIG. 3, the device 318 includes a housing 322, which can be configured to accept a filter medium 320 therein. The filter medium 320 can be a woven hybrid water filter medium, as previously described, for instance. Such a medium can include a modified polyacrylic fiber configured to remove heavy metal ions present in drinking water by chelating the heavy metal ions. Such a medium can further include an unmodified polyacrylic fiber configured to absorb total organic carbon from drinking water.

Embodiments of the present disclosure are not limited to a particular size, design, and/or configuration of the device 318. In some embodiments, the device 318 can be a cartridge for use in a water filtration system, for instance.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for forming a water filter medium, comprising:
modifying a polymeric fiber using an amine compound to form a chelating fiber; and
combining the chelating fiber and an activated carbon fiber to form a hybrid water filter medium.

2. The method of claim 1, wherein modifying the polymeric fiber using the amine compound includes applying an amination treatment to the polymeric fiber.

3. The method of claim 1, wherein the polymeric fiber is polyacrylonitrile.

4. The method of claim 1, wherein the polymeric fiber is one of: polyacrylonitrile, polyvinyl alcohol, polypropylene, and polyacrylic.

5. The method of claim 1, wherein the chelating fiber includes at least one of:
a phosphorus chelating fiber;
a sulfur chelating fiber; and
an amino chelating fiber;

6. The method of claim 1, wherein the chelating fiber includes a chelating group, and wherein the chelating group is amidoxime, amide, amine, or thiourea.

7. The method of claim 1, wherein combining the chelating fiber and the activated carbon fiber includes weaving the chelating fiber and the activated carbon fiber.

8. The method of claim 1, wherein combining the chelating fiber and the activated carbon fiber includes spinning the chelating fiber and the activated carbon fiber.

9. The method of claim 1, wherein the method includes:
determining a heavy metal ion content of a drinking water sample and a total organic carbon content of the drinking water sample; and
combining a particular quantity of the chelating fiber and a particular quantity of the activated carbon fiber determined based on the heavy metal ion content and the total organic carbon content.

10. The method of claim 1, wherein the method includes modifying the polymeric fiber using at least one of: hydrazine, hydroxylamine hydrochloride, ethanolamine, ethylene diamine, tetramethylene diamine, and diethylene triamine.

11. A water filter medium, comprising:
a modified polyacrylic fiber having a plurality of chelating groups configured to chelate heavy metal ions present in drinking water; and
an activated polyacrylic fiber configured to absorb total organic carbon from drinking water, wherein the modified polyacrylic fiber and the activated polyacrylic fiber are woven together.

12. The medium of claim 11, wherein the polyacrylic fiber is modified using an amination treatment.

13. The medium of claim 11, wherein the medium is a fabric sheet.

14. The medium of claim 11, wherein the plurality of chelating groups is configured to chelate copper, zinc, cadmium, and mercury ions.

15. The medium of claim 11, wherein the plurality of chelating groups is configured to chelate silver, gold, and arsenic ions.

16. The medium of claim 11, wherein the plurality of chelating groups is configured to chelate copper, nickel, iron, zinc, and lead ions.

17. The medium of claim 11, wherein a ratio of the modified polyacrylic fiber to the activated polyacrylic fiber is selected based on an amount of total organic carbon in the drinking water.

18. The medium of claim 11, wherein a ratio of the modified polyacrylic fiber to the activated polyacrylic fiber is selected based on an amount of heavy metal ions in the drinking water.

19. A device for filtering water, comprising:
a woven hybrid water filter medium, comprising:
a modified polyacrylic fiber configured to remove heavy metal ions present in drinking water by chelating the heavy metal ions; and
an activated carbon fiber configured to absorb total organic carbon from drinking water; and
a housing configured to accept the filter medium therein.

20. The device of claim 17, wherein the medium is a fabric.
